(19) United States
(12) Patent Application Publication
(10) Pub. No.: US 2012/0096854 A1
(43) Pub. Date: Apr. 26, 2012

(54) ENGINE EXHAUST TREATMENT SYSTEM AND METHOD FOR TREATING EXHAUST GAS FROM AN ENGINE

(76) Inventor: Shashi KIRAN, Erie, PA (US)

(21) Appl. No.: 12/909,142

(22) Filed: Oct. 21, 2010

(51) Int. Cl. F02D 23/00; F01N 3/10

(52) U.S. Cl. 60/602; 60/299

(57) ABSTRACT

An engine exhaust treatment system includes an upstream turbocharger fluidly coupled with an engine and disposed downstream from the engine along a flow path of exhaust gas generated by the engine, a downstream turbocharger fluidly coupled with the upstream turbocharger and disposed downstream from the upstream turbocharger along the flow path, and an after-treatment receptacle fluidly coupled with and disposed between the upstream and downstream turbochargers along the flow path. The after-treatment receptacle is configured to receive a first filter medium that removes at least one of particulates or a gas constituent from the exhaust gas generated by the engine. In an embodiment, the exhaust gas can flow through the upstream turbocharger prior to flowing through the after-treatment receptacle and can flow through the after-treatment receptacle prior to flowing through the downstream turbocharger along the flow path.

### BACKGROUND

1. Technical Field

The subject matter described herein relates to engines that produce an exhaust gas.

2. Discussion of Art

Known vehicles include engines that provide tractive effort or power to propel the vehicles. For example, some known rail vehicles and automobiles include diesel engines that provide tractive effort to propel the rail vehicles and automobiles. The engines combust fuel and produce exhaust gas as a by product. The exhaust gas can be produced at significantly high temperatures and pressures, and can include components such as component soot and nitrogen oxide (NOₓ).

To reduce the temperature, pressure, and/or components expelled by engines into the atmosphere, some vehicles include after-treatment systems having filters that remove components from the exhaust gas. Some known after-treatment systems include filters located downstream from the engine. The exhaust gas flows from the engine and through the filters before being expelled into the atmosphere.

The performance of the filter media used in some known filters may be sensitive to the pressure or temperature of the exhaust gas. For example, as the temperature, pressure, or flow rate of the exhaust gas flowing from the engine increases or decreases, the filters may be less efficient in removing the components from the exhaust gas. Moreover, the service lives of the filters, or the time periods over which the filter media can remove components from the exhaust gas, may be decreased at faster rates when the pressure, temperature, or flow rate of the exhaust gas increases.

It may be desirable to have an engine exhaust treatment system and method for treating exhaust of an engine that avoids reducing the efficiency and/or service lives of the filters in the system.

### BRIEF DESCRIPTION

In one embodiment, an engine exhaust treatment system is provided. The system comprises: an upstream turbocharger fluidly coupled with an engine and disposed downstream from the engine along a flow path of exhaust gas generated by the engine; a downstream turbocharger fluidly coupled with the upstream turbocharger and disposed downstream from the upstream turbocharger along the flow path; and an after-treatment receptacle fluidly coupled with and disposed between the upstream and downstream turbochargers along the flow path. The after-treatment receptacle is configured to receive a first filter medium that removes at least one of particulates or a gas constituent from the exhaust gas generated by the engine. In an embodiment, the exhaust gas can flow through the upstream turbocharger prior to flowing through the after-treatment receptacle and can flow through the after-treatment receptacle prior to flowing through the downstream turbocharger along the flow path.

Another embodiment relates to a method for treating exhaust gas from an engine that travels along a flow path from the engine to a treatment system. The treatment system has an upstream turbocharger, an after-treatment receptacle that is fluidly coupled with and disposed downstream the flow path from the upstream turbocharger, and a downstream turbocharger that is fluidly coupled with and disposed downstream the flow path from the after-treatment receptacle. The method comprises filtering a particulate or reacting a gas constituent of the exhaust gas after the exhaust gas has passed through the upstream turbocharger but before the exhaust gas has passed through the downstream turbocharger.

In another embodiment, an engine exhaust treatment system is provided that includes an upstream temperature reduction device, an after-treatment receptacle, and a downstream temperature reduction device. The upstream temperature reduction device is coupled with an engine and disposed downstream from the engine along a flow path of exhaust gas generated by the engine. The upstream temperature reduction device reduces a temperature of the exhaust flowing from the engine. The after-treatment receptacle is fluidly coupled with and disposed downstream from the upstream temperature reduction device along the flow path. The after-treatment receptacle is configured to receive a filter medium that removes at least one of particulates or a gas constituent from the exhaust gas flowing from the upstream temperature reduction device along the flow path. The downstream temperature reduction device is fluidly coupled with and disposed downstream from the after-treatment receptacle along the flow path. The downstream temperature reduction device reduces the temperature of the exhaust gas flowing from the after-treatment receptacle along the flow path.

### BRIEF DESCRIPTION OF THE DRAWINGS

FIG. 1 is a view of a powered rail vehicle in accordance with one embodiment.

FIG. 2 is a view of an engine exhaust treatment system shown in FIG. 1 in accordance with one embodiment.

FIG. 3 is a flowchart of a method for treating exhaust gas from an engine in accordance with one embodiment.

### DETAILED DESCRIPTION

The subject matter described herein relates to engine exhaust treatment systems and methods for treating exhaust gas from an engine. In one embodiment, the systems and methods provide for a filter medium that is positioned between two turbochargers along a flow path of exhaust gas that is expelled from an engine, such as a diesel engine of a powered rail vehicle. The turbochargers include an upstream turbocharger located between the engine and the filter medium and a downstream turbocharger located downstream from the filter medium along the flow path of the exhaust gas. The filter medium removes one or more particulates and/or reacts with or catalyzes one or more constituents in the gas exhaust to remove the particulates or constituents from the exhaust gas before the exhaust gas is expelled into the atmosphere. The turbochargers control a temperature and/or pressure of the exhaust gas such that the temperature and/or pressure of the exhaust gas passing through the filter medium is within an operating range of the filter medium. Maintaining the temperature and/or pressure of the exhaust gas within the operating range of the filter medium can increase the efficiency and/or service life of the filter medium.

It should be noted that although one or more embodiments may be described in connection with the engines of powered rail vehicles, the embodiments described herein are not limited to trains. In particular, one or more embodiments may be implemented in connection with different types of vehicles. Suitable vehicles can include mining vehicles, over the road trucks, automobiles, marine vessels, and the like.

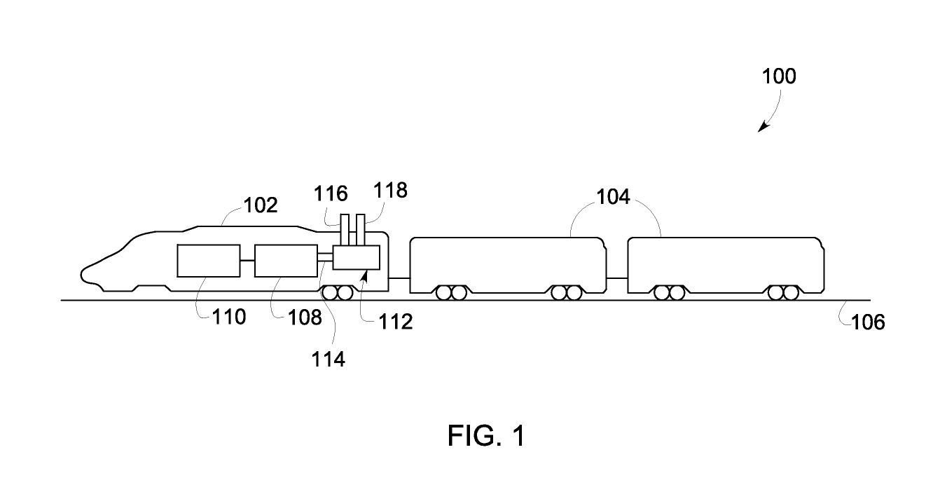

FIG. 1 is a view of a powered rail vehicle 100 in accordance with one embodiment. The rail vehicle 100 includes a lead powered unit 102 coupled with several trailing cars 104 that travel along one or more rails 106. In one embodiment, the lead powered unit 102 is a locomotive disposed at the front end of the rail vehicle 100 and the trailing cars 104 are cargo cars for carrying passengers and/or other cargo. The lead powered unit 102 includes an engine 108, such as a diesel engine. The engine 108 provides tractive effort to propel the rail vehicle 100. For example, the engine 108 may be coupled with a current-generating device 110, such as an alternator or generator, that creates electric current based on movement of the engine 108. The electric current is supplied to motors (not shown) that propel the vehicle.

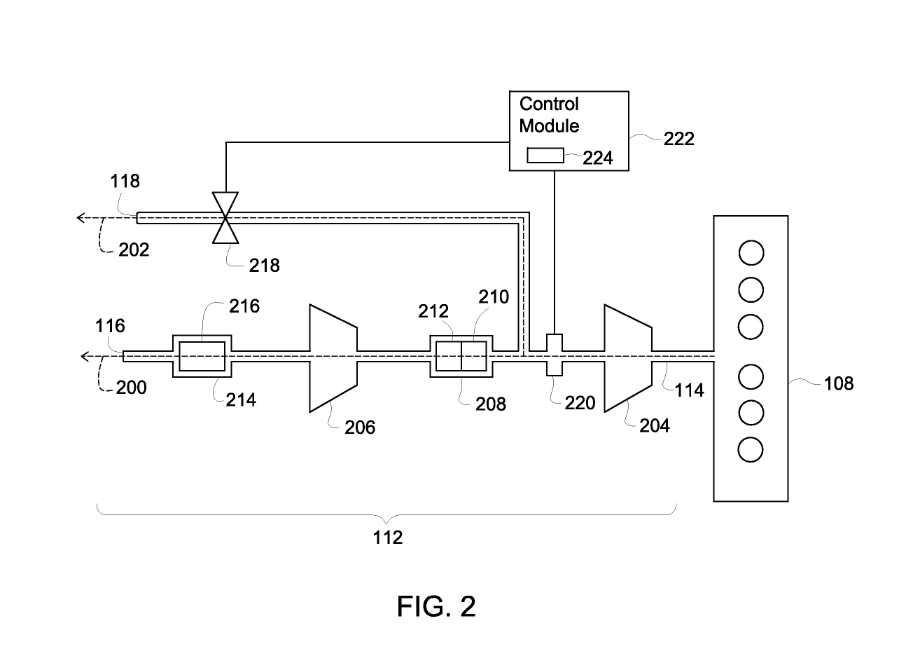

The engine 108 is fluidly coupled with an engine exhaust treatment system 112. For example, the treatment system 112 may be coupled with the engine 108 by one or more conduits 114 that direct exhaust gas generated by the engine 108 to the treatment system 112. The treatment system 112 filters the exhaust gas by removing one or more particulates and/or constituents of the exhaust gas prior to expelling the exhaust gas to the atmosphere outside of the vehicle. In the illustrated embodiment, the treatment system 112 includes a filtered exhaust outlet 116 and an unfiltered exhaust outlet 118. The treatment system 112 directs the exhaust gas that is filtered by the treatment system 112 out to the atmosphere through the filtered exhaust outlet 116 and directs the exhaust gas that is not filtered through the unfiltered exhaust outlet 118. The exhaust gas may be unfiltered and directed through the unfiltered exhaust outlet 118 when a service life of a filter 210, 212 (shown in FIG. 2) in the treatment system 112 has expired and/or a temperature of the exhaust gas flowing into the filter 210, 212 exceeds a threshold.

FIG. 2 is a view of the treatment system 112 in accordance with one embodiment. The treatment system 112 is coupled with the engine 108 by the conduit 114, as described above. In one embodiment, the engine 108 is an exhaust gas recirculating (EGR) diesel engine that recirculates at least some of the exhaust gas generated by one or more cylinders or pistons of the engine 108. The exhaust gas is expelled by the engine 108 into the treatment system 112 and may travel through the treatment system 112 to the external atmosphere along a filtering flow path 200. As described below, the exhaust gas that flows through the treatment system 112 along the filtering flow path 200 is filtered by the treatment system 112. Alternatively, the exhaust gas may be diverted from the filtering flow path 200 and travel to the external atmosphere along a non-filtering flow path 202. The exhaust gas that flows along the filtering flow path 200 is expelled into the atmosphere through the filtered exhaust outlet 116 while the exhaust gas that flows along the non-filtering flow path 202 is expelled into the atmosphere through the unfiltered exhaust outlet 118.

The treatment system 112 includes an upstream turbocharger 204 and a downstream turbocharger 206 fluidly coupled with each other along the filtered flow path 200. The treatment system 112 also includes an after-treatment receptacle 208 that is fluidly coupled with the turbochargers 204, 206 and disposed along with filtered flow path 200 between the turbochargers 204, 206. The after-treatment receptacle 208 includes a body, housing, casing, or other structure that receives and holds one or more first filters 210, 212. The after-treatment receptacle 208 holds the filters 210, 212 such that the filtered flow path 200 passes through the filters 210, 212 and the exhaust gas passes through and is filtered by the filters 210, 212 along the filtered flow path 200.

The filters 210, 212 include filter media that removes one or more particulates and/or constituents from the exhaust gas moving along the filtered flow path 200. The filter 210 may be a flow through filter (FTF) or diesel particulate filter (DPF) that permits the exhaust gas to flow through the filter 210 as the filter 210 removes particulates, such as soot, from the exhaust gas. By way of non-limiting example only, the filter 210 may include one or more of a cordierite filter, a silicon carbide (SiC) filter, a filter formed from fibrous ceramic or metal materials, or a paper core filter. The filter 212 may be a chemical filter that uses chemical reactions or processes to break down or chemically alter constituents in the exhaust gas. For example, the filter 212 can be a diesel oxidation catalyst (DOC) filter that reacts with or catalyzes one or more constituents, such as nitrogen oxide (NOₓ), in the exhaust gas. The filter 212 may include a catalyst such as palladium (Pd) or platinum (Pt) that oxidizes components such as carbon monoxide, hydrocarbons, or NOₓ and SOx to convert the components into another non-polluting chemical species, such as carbon dioxide, water, nitrogen, or nitrogen dioxide.

The filters 210, 212 may be associated with filtering efficiencies. The filtering efficiency of a filter 210, 212 represents the percentage or fraction of one or more particulates and/or constituents in the exhaust gas that is removed by the filter 210, 212 as the exhaust gas flows through the filter 210, 212. A greater filtering efficiency indicates that the filter 210, 212 removes a larger percentage or fraction of particulates or constituents from the exhaust gas. Conversely, a smaller filtering efficiency indicates that fewer particulates or constituents are removed from the exhaust gas by the filter 210, 212.

The filters 210, 212 may be associated with service lives. A service life of a filter 210, 212 represents the time period or duration that the filter 210, 212 may be used to remove particulates and/or constituents from the exhaust gas. A filter 210, 212 may be ineffective to remove the particulates and/or constituents from the exhaust gas once the service life of the filter 210, 212 has expired.

The filtering efficiency and/or service life of the filter 210 and/or 212 may be based on the temperature of the exhaust gas that flows through the filter 210, 212. For example, as the temperature of the exhaust gas changes, the filtering efficiency of the filter 210, 212 may change. In another example, the service life of the filter 210, 212 may decrease at a faster rate as the temperature of the exhaust gas flowing through the filter 210, 212 changes.

One or more of the filters 210, 212 may have an operating range of exhaust gas temperatures associated with the filter 210, 212. The operating range represents the range of temperatures of the exhaust gas that the filter 210, 212 has a filtering efficiency that exceeds a predetermined threshold. In one embodiment, one or more of the filters 210, 212 has a filtering efficiency that decreases when the temperature of the exhaust gas flowing through the filter 210, 212 exceeds an upper threshold temperature and when the temperature of the exhaust gas drops below a lower threshold temperature. The filtering efficiency of the filter 210 and/or 212 may exceed a threshold efficiency when the temperature of the exhaust gas is between the upper and lower threshold temperatures. By way of example only, the filter 210 and/or 212 has a filtering efficiency of at least 99%, 95%, 90%, 80%, or 70% when the exhaust gas temperatures are between the upper and lower threshold temperatures. The operating range of exhaust gas temperatures that fall within the upper and lower threshold temperatures may be in a range of from about 200 degrees Celsius to 275 degrees Celsius. Alternatively, the operating range of exhaust gas temperatures may be in a range of from about 275 degrees Celsius to 350 degrees Celsius, 350 degrees Celsius to 400 degrees Celsius, 400 degrees Celsius to 500 degrees Celsius, or higher than 500 degrees Celsius. In one embodiment, the upper threshold temperature of the operating range is less than about 1200 degrees Celsius and the lower threshold temperature of the operating range is at least about 150 degrees Celsius.

One or more of the filters 210, 212 may have an operating range of exhaust gas pressures. Similar to the operating range of exhaust gas temperatures, the operating range of exhaust gas pressures represents the range of pressures of the exhaust gas or the rates of flow of the exhaust gas that the filter 210, 212 has a filtering efficiency that exceeds a determined threshold. In one embodiment, one or more of the filters 210, 212 has a filtering efficiency that decreases when the pressure or flow rate of the exhaust gas flowing through the filter 210, 212 exceeds an upper threshold pressure or flow rate and when the pressure or flow rate of the exhaust gas drops below a lower threshold pressure or flow rate.

The upstream and downstream turbochargers 204, 206 control the temperature and/or pressure of the exhaust gas that flows along the filtered flow path 200 such that the temperature and/or pressure remains within the temperature and/or pressure operating ranges of the filter 210 and/or 212. For example, the upstream turbocharger 204 is located upstream from the filters 210, 212 along the direction of flow of the exhaust gas along the filtered flow path 200. The upstream turbocharger 204 has a pressure ratio that represents the ratio of the exhaust gas pressure that enters into the upstream turbocharger 204 from the engine 108 to the exhaust gas pressure that leaves the upstream turbocharger 204 toward the filters 210, 212 along the filtered flow path 200. The pressure ratio may indicate the amount of drop or decrease in pressure (or, “pressure drop”) of the exhaust gas that flows through the upstream turbocharger 204. The downstream turbocharger 206 is located downstream from the filters 210, 212 along the filtered flow path 200 and has a pressure ratio that represents the ratio of the exhaust gas pressure that enters into the downstream turbocharger 206 from the filters 210, 212 to the exhaust gas pressure that leaves the downstream turbocharger 206 toward the filtered exhaust outlet 116 along the filtered flow path 200. Turbochargers 204, 206 having larger pressure ratios cause the exhaust gas pressure and/or the temperature of the exhaust gas to decrease or drop as the exhaust gas flows through the turbocharger 204, 206 by greater amounts than turbochargers 204, 206 having smaller pressure ratios.

The pressure ratios of the upstream and downstream turbochargers 204, 206 may differ from each other. For example, the pressure ratio of the upstream turbocharger 204 may be greater than the pressure ratio of the downstream turbocharger 206. In one embodiment, the pressure ratio of the upstream turbocharger 204 is 3.5 to 4.0 while the pressure ratio of the downstream turbocharger 206 is 2.0 to 3.0. Alternatively, the pressure ratio of the downstream turbocharger 206 may be greater than the pressure ratio of the upstream turbocharger 204. In another embodiment, the pressure ratios of the upstream and downstream turbochargers 204, 206 are approximately the same.

The turbochargers 204, 206 may change the temperature of the exhaust gas by changing the pressure of the exhaust gas. For example, by reducing the pressure or flow rate of the exhaust gas, the turbochargers 204, 206 may reduce the temperature of the exhaust gas. The reduction in temperature of the exhaust gas may be based on the pressure ratio of the turbocharger 204, 206. As the pressure ratio of a turbocharger 204, 206 increases, the reduction in temperature of the exhaust gas flowing through the turbocharger 204, 206 increases. By “reducing” or “reduction” (and other forms thereof), it is meant that the pressure, flow rate, or temperature of the exhaust gas flowing into the turbocharger 204 or 206 is greater or larger than the pressure, flow rate, or temperature of the exhaust gas flowing out of the same turbocharger 204 or 206.

The upstream turbocharger 204 changes the pressure and/or temperature of the exhaust gas that is expelled from the engine 108 such that the pressure and/or temperature of the exhaust gas falls within an operating range of pressures and/or temperatures of the filter 210 and/or 212 prior to the exhaust gas reaching the filters 210, 212. For example, if the exhaust gas coming from the engine 108 has a pressure or temperature that is greater than the upper threshold pressure or temperature of an operating range of the filter 210 and/or 212, then the upstream turbocharger 204 can reduce the pressure and/or temperature of the exhaust gas such that the pressure and/or temperature of the exhaust gas flowing into the upstream turbocharger 204 is larger than the pressure and/or temperature of the exhaust gas flowing out of the upstream turbocharger 204. The upstream turbocharger 204 reduces the pressure and/or temperature such that the exhaust gas pressure or temperature falls within the operating range of the filter 210 and/or 212. By achieving or maintaining a pressure or temperature of the exhaust gas that flows into the filters 210, 212 within operating ranges of the filters 210, 212, the filtering efficiencies of the filters 210, 212 may be maintained above a predetermined threshold efficiency. By achieving or maintaining a pressure or temperature of the exhaust gas that flows into the filters 210, 212 within operating ranges of the filters 210, 212, the service lives of the filters 210, 212 may not be reduced at an advanced rate.

The geographic location or area in which the engine 108 is located may have limits to the temperature and/or pressure at which exhaust gas is expelled from the vehicle (shown in FIG. 1). For example, to reduce pollution, a country, state, county, or city may limit the permissible pressure, or flow rate, of exhaust gas that is expelled from the vehicle. The temperature of the exhaust gas also may be required to be below a predetermined threshold. The pressure and/or temperature threshold for the exhaust gas that is expelled from the filtered exhaust outlet 116 may be outside of the operating range of one or more of the filters 210, 212. For example, the pressure and/or temperature threshold may be less than a lower threshold of the operating range of the filter 210 or 212.

The downstream turbocharger 206 may change the pressure and/or temperature of the exhaust gas that is received from the filters 210, 212 such that the pressure and/or temperature of the exhaust gas that is expelled into the atmosphere through the filtered exhaust outlet 116 is less than a predetermined pressure or temperature threshold. For example, if the exhaust gas flowing from the filters 210, 212 has a pressure or temperature that is greater than a limit established for a geographic area, the downstream turbocharger 206 can reduce the pressure and/or temperature of the exhaust gas to be below the limit.

In one embodiment, the turbochargers 204, 206 control the exhaust gas pressure and/or temperature that is delivered to the filters 210, 212 and that is expelled from the filtered exhaust outlet 116 such that the pressure and/or temperature of the exhaust gas that flows through the filters 210, 212 falls within an operating range of the filters 210, 212 and the pressure and/or temperature of the exhaust gas that is expelled from the filtered exhaust outlet 116 is below a predetermined threshold. For example, the upstream turbocharger 204 can reduce the temperature and/or pressure of the exhaust gas flowing into the upstream turbocharger 204 relative to the exhaust gas flowing out of the upstream turbocharger 204, and the downstream turbocharger 206 can reduce the temperature and/or pressure of the exhaust gas flowing into the downstream turbocharger 206 relative to the exhaust gas flowing out of the downstream turbocharger 206. As a result, the temperature and/or pressure of the exhaust gas flowing into the upstream turbocharger 204 may be increased, or greater than, the temperature and/or pressure of the exhaust gas flowing into the downstream turbocharger 206 and the exhaust gas that flows out of the downstream turbocharger 206. The exhaust gas flowing out of the upstream turbocharger 204 and into the downstream turbocharger 206 may have a temperature and/or pressure that is decreased, or smaller than, the temperature and/or pressure of the exhaust gas flowing into the upstream turbocharger 204 but that is increased, or greater than, the temperature and/or pressure flowing out of the downstream turbocharger 206.

In an alternative embodiment, the upstream and downstream turbochargers 204, 206 may be replaced or supplemented with temperature reduction devices that change the temperature of the exhaust gas flowing through the devices. For example, a heat sink or other component that removes heat or thermal energy from the exhaust gas may be used in place of or addition to the upstream turbocharger 204 and/or the downstream turbocharger 206. In one embodiment, the upstream and downstream turbochargers 204, 206 may be temperature reduction devices if the upstream and downstream turbochargers 204, 206 reduce the temperature of the exhaust gas. The temperature reduction devices reduce the temperature of the exhaust gas flowing to the filters 210, 212 so that the exhaust gas temperature falls within one or more operating ranges of the filters 210, 212. The temperature reduction devices also may reduce the temperature of the exhaust gas expelled through the filtered exhaust outlet 116 to be below a predetermined limit.

In the illustrated embodiment, the treatment system 112 includes an outlet treatment receptacle 214 (also referred to herein as a post-turbocharger treatment receptacle) fluidly coupled with and disposed downstream from the downstream turbocharger 206 along the filtered flow path 200. The outlet treatment receptacle 214 includes a body, housing, casing, or other structure that receives and holds one or more second filters 216. The outlet treatment receptacle 214 holds the filter 216 such that the filtered flow path 200 and the exhaust gas passes through the filter 216 prior to being expelled into the atmosphere through the filtered exhaust outlet 116. While only one filter 216 is shown in FIG. 2, alternatively the outlet treatment receptacle 214 may include two or more filters 216.

Similar to the first filters 210, 212, the second filter 216 includes a second filter medium or media that removes one or more particulates and/or constituents from the exhaust gas moving along the filtered flow path 200. By way of example only, the filter 216 may be a flow through filter (FTF), a diesel particulate filter (DPF), and/or a diesel oxidation catalyst (DOC) filter. Also similar to the filters 210, 212, the filter 216 may be associated with an operating range of exhaust gas pressures and/or temperatures. The turbochargers 204, 206 may change the pressure and/or temperature of the exhaust gas that flows into the filter 216 such that the exhaust gas pressure and/or temperature falls within the operating range of the filter 216.

In the illustrated embodiment, the treatment system 112 includes a bypass valve 218 disposed along the unfiltered flow path 202. The bypass valve 218 is moveable between opened and closed positions. In the opened position, the bypass valve 218 permits exhaust gas to flow along the unfiltered flow path 202 and into the atmosphere through the unfiltered exhaust outlet 118. In the closed position, the bypass valve 218 prevents the exhaust gas from flowing along the unfiltered flow path 202 and into the atmosphere through the unfiltered exhaust outlet 118. As shown in FIG. 2, the unfiltered flow path 202 is fluidly coupled with the filtered flow path 200 upstream of the after-treatment receptacle 208 along the filtered flow path 200. For example, the unfiltered flow path 202 branches off of the filtered flow path 200 between the upstream turbocharger 204 and the after-treatment receptacle 208. Alternatively, the unfiltered flow path 202 is fluidly coupled with the filtered flow path 200 in another position, such as between the upstream turbocharger 204 and the engine 108.

The bypass valve 218 may be opened to divert exhaust gas away from the filters 210, 212 and out of the unfiltered exhaust outlet 118. For example, if the temperature or pressure of the exhaust gas is too high for the filters 210, 212, the bypass valve 218 can be opened to divert the exhaust gas away from the filters 210, 212. The temperature or pressure of the exhaust gas may exceed a predetermined threshold of the filter 210 and/or 212, such as the upper threshold pressure or temperature of an operating range of the filter 210 or 212. The temperature or pressure of the exhaust gas may increase and exceed the upper threshold of the operating range due to a variety of causes. By way of example only, the travel of the vehicle (shown in FIG. 1) into an unventilated tunnel or other enclosure, the failure or breakdown of a temperature reduction device or cooling system of the engine 108, or the failure or breakdown of a component of the engine 108 may cause the exhaust gas temperature to increase to temperatures that are outside of the operating ranges of the filter 210 and/or 212, or to temperatures that exceed other predetermined thresholds of the filter 210 and/or 212.

In order to avoid the exhaust gas having the relatively high temperature from passing through the filter 210 and/or 212, the bypass valve 218 is opened to divert the exhaust gas away from the filtered flow path 200 before the exhaust gas flows through the filters 210, 212. The bypass valve 218 may be manually opened or closed in one embodiment.

Alternatively, the treatment system 112 may include a temperature sensor 220 and a control module 222 that open or close the bypass valve 218. The temperature sensor 220 includes a device or apparatus that measures the temperature of the exhaust gas in the filtered flow path 200 in a location that is upstream of the after-treatment receptacle 208. By way of example only, the temperature sensor 220 may include thermocouples positioned in or proximate to the filtered flow path 200. The temperature sensor 220 is communicatively coupled with the control module 222 to communicate the sampled exhaust gas temperatures to the control module 222.

The control module 222 may include a processor, such as a computer processor, controller, microcontroller, or other type of logic device, that operates based on sets of instructions stored on a tangible and non-transitory computer readable storage medium 224. The computer readable storage medium 224 may be an electrically erasable programmable read only memory (EEPROM), simple read only memory (ROM), programmable read only memory (PROM), erasable programmable read only memory (EPROM), FLASH memory, a hard drive, or other type of computer memory.

The control module 222 receives the exhaust gas temperature from the temperature sensor 220 and determines if the exhaust gas is too hot to flow into the filters 210, 212. For example, the control module 222 may compare the exhaust gas temperature to a predetermined threshold temperature. If the exhaust gas temperature exceeds the threshold temperature, then the exhaust gas temperature may indicate that the exhaust gas is too hot to flow into the filter 210 or 212. As a result, the control module 222 causes the bypass valve 218 to open. For example, the control module 222 may be coupled with an actuator that turns or otherwise opens the bypass valve 218 to direct the hot exhaust gas to the unfiltered flow path 202 and the unfiltered exhaust outlet 118. If the bypass valve 218 is already open and the exhaust gas temperature falls below the threshold temperature, then the control module 222 may cause the bypass valve 218 to close to direct the exhaust gas through the filters 210, 212.

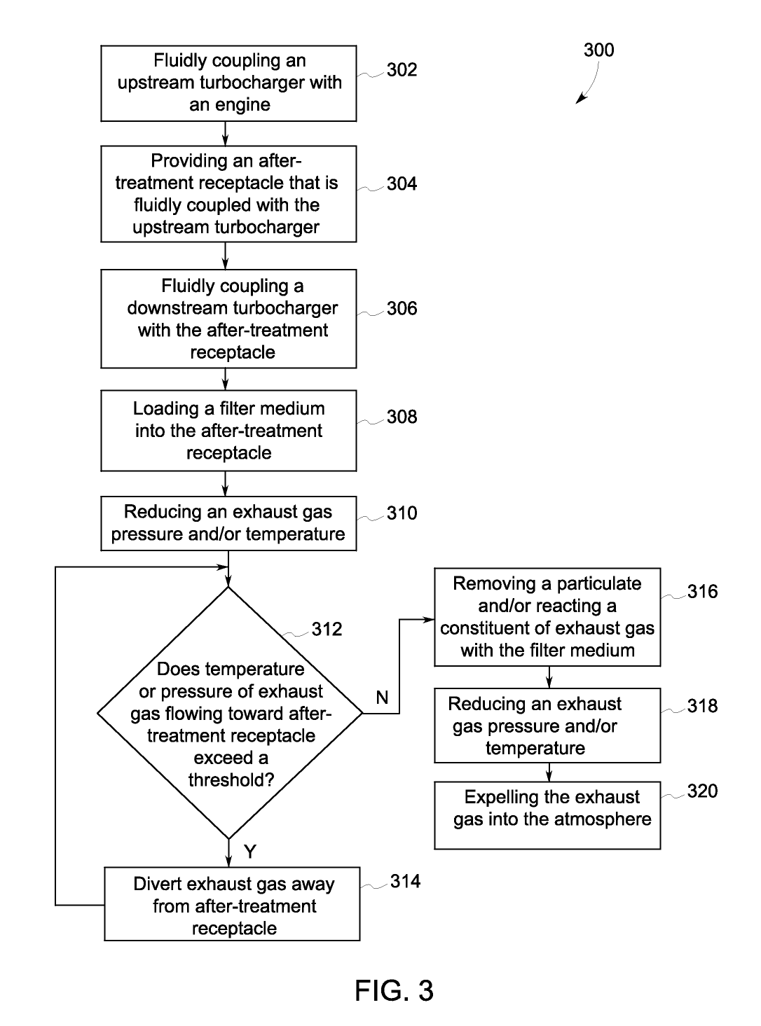

FIG. 3 is a flowchart of a method 300 for treating exhaust gas from an engine in accordance with one embodiment. The method 300 may be used with the treatment system 112 (shown in FIG. 1) to filter exhaust gas from the engine 108 (shown in FIG. 1) while maintaining the temperature and/or pressure of the exhaust gas within one or more operating ranges of the filter 210 and/or 212 (shown in FIG. 2).

At 302, an upstream turbocharger is fluidly coupled with the engine. For example, the upstream turbocharger 204 (shown in FIG. 2) may be coupled with the engine 108 (shown in FIG. 1) such that the upstream turbocharger 204 receives the exhaust gas from the engine 108. Alternatively, a temperature reduction device may be fluidly coupled with the engine 108.

At 304, an after-treatment receptacle is provided. The after-treatment receptacle is fluidly coupled with the upstream turbocharger and is configured to hold one or more filters. For example, the after-treatment receptacle 208 (shown in FIG. 2) may be fluidly coupled with the upstream turbocharger 204 (shown in FIG. 2) downstream from the upstream turbocharger 204 along the filtered flow path 200 (shown in FIG. 2)

At 306, a downstream turbocharger is fluidly coupled with the after-treatment receptacle. For example, the downstream turbocharger 206 (shown in FIG. 2) may be coupled with the after-treatment receptacle 208 (shown in FIG. 2) downstream from the after-treatment receptacle 208 along the filtered flow path 200 (shown in FIG. 2).

At 308, a first filter medium is loaded into the after-treatment receptacle. For example, one or more first filters 210, 212 (shown in FIG. 2) may be inserted into the after-treatment receptacle 208 (shown in FIG. 2) such that exhaust gas travelling along the filtered flow path 200 (shown in FIG. 2) will flow through the filters 210, 212.

At 310, a pressure and/or temperature of the exhaust gas is reduced. For example, the upstream turbocharger 204 (shown in FIG. 2) may receive the exhaust gas from the engine 108 (shown in FIG. 1) and reduce the pressure, flow rate, and/or temperature of the exhaust gas.

At 312, a determination is made as to whether the temperature or pressure of the exhaust gas flowing from the engine and toward the filter medium exceeds a predetermined threshold. For example, a determination may be made as to whether the temperature of the exhaust gas flowing from the upstream turbocharger 204 (shown in FIG. 2) exceeds a predetermined threshold temperature of the filter 210 or 212 (shown in FIG. 2). If the exhaust gas temperature or pressure exceeds the threshold, then the exhaust gas temperature or pressure may be too high to pass through the filter medium. For example the exhaust gas temperature or pressure may be outside the operating range of the filter 210 or 212. As a result, flow of the method 300 proceeds to 314.

At 314, the exhaust gas is diverted away from the filter medium. For example, the bypass valve 218 (shown in FIG. 2) may be opened to cause the exhaust gas having the relatively high temperature or pressure to be directed away from the filters 210, 212 (shown in FIG. 2) along the unfiltered flow path 202 (shown in FIG. 2). The exhaust gas is expelled into the atmosphere through the unfiltered exhaust outlet 118 (shown in FIG. 1). Flow of the method 300 returns to 312 where another determination is made as to whether the temperature or pressure of the exhaust gas exceeds the threshold. The method 300 may continue in a loop-wise manner until the temperature or pressure no longer exceeds the threshold.

On the other hand, at 312, if the temperature or pressure of the exhaust gas does not exceed the threshold, then the exhaust gas may flow toward and be filtered by the filter medium. As a result, flow of the method 300 proceeds to 316.

At 316, one or more particulates and/or constituents of the exhaust gas are removed by the filter medium. For example, the filters 210, 212 (shown in FIG. 2) may remove particulates such as soot and/or catalyze NOₓ in the exhaust gas to remove the particulates and constituents from the exhaust gas.

At 318, a pressure and/or temperature of the exhaust gas is reduced. For example, the downstream turbocharger 206 (shown in FIG. 2) may receive the exhaust gas that passed through the filter 210 and/or 212 (shown in FIG. 2) and reduce the pressure, flow rate, and/or temperature of the exhaust gas. The downstream turbocharger 206 may reduce the pressure and/or temperature below a predetermined limit or threshold associated with exhaust gas that is expelled into the atmosphere.

At 320, the exhaust gas is expelled into the atmosphere. For example, the exhaust gas may be directed into the air surrounding the vehicle (shown in FIG. 1) through the filtered exhaust outlet 116 (shown in FIG. 1). Alternatively, the exhaust gas may pass through an additional filter medium, such as the filter 216 (shown in FIG. 2), to remove one or more additional particulates or constituents of the exhaust gas prior to expelling the exhaust gas into the atmosphere.

In one embodiment, an engine exhaust treatment system is provided. The system comprises: an upstream turbocharger fluidly coupled with an engine and disposed downstream from the engine along a flow path of exhaust gas generated by the engine; a downstream turbocharger fluidly coupled with the upstream turbocharger and disposed downstream from the upstream turbocharger along the flow path; and an after-treatment receptacle fluidly coupled with and disposed between the upstream and downstream turbochargers along the flow path, the after-treatment receptacle configured to receive a first filter medium that removes at least one of particulates or a gas constituent from the exhaust gas generated by the engine, whereby the exhaust gas can flow through the upstream turbocharger prior to flowing through the after-treatment receptacle and can flow through the after-treatment receptacle prior to flowing through the downstream turbocharger along the flow path.

In another aspect, the after-treatment receptacle is disposed between the upstream and downstream turbochargers such that a pressure of the exhaust gas flowing through the after-treatment receptacle is smaller than the pressure of the exhaust gas flowing into the upstream turbocharger and is greater than the pressure of the exhaust gas flowing out of the downstream turbocharger.

In another aspect, a first pressure ratio of the upstream turbocharger differs from a second pressure ratio of the downstream turbocharger.

In another aspect, the after-treatment receptacle is disposed between the upstream and downstream turbochargers such that a temperature of the exhaust gas flowing through the after-treatment receptacle is reduced relative to the temperature of the exhaust gas flowing into the upstream turbocharger and is increased relative to the temperature of the exhaust gas flowing out of the downstream turbocharger.

In another aspect, the filter medium is a flow-through filter capable of removing the particulates from the exhaust gas or an oxidation catalyst filter capable of catalyzing the gas constituent prior to the exhaust gas flowing into the downstream turbocharger.

In another aspect, a bypass valve is fluidly coupled with both the upstream turbocharger and the after-treatment receptacle, and the bypass valve having an open position and a closed position, wherein the bypass valve diverts the exhaust gas away from the after-treatment receptacle when the bypass valve is in the open position.

In another aspect, the bypass valve is fluidly coupled with the upstream turbocharger and the after-treatment receptacle between the upstream turbocharger and the after-treatment receptacle along the flow path.

In another aspect, a post-turbocharger treatment receptacle is fluidly coupled with and disposed downstream from the downstream turbocharger along the flow path, and the post-turbocharger treatment receptacle is configured to receive a second filter medium that removes one or more particulates from the exhaust gas generated by the engine.

In another aspect, the engine exhaust treatment system in disposed within a vehicle.

In another embodiment, a method for treating exhaust gas from an engine that travels along a flow path from the engine to a treatment system, and the treatment system having an upstream turbocharger, an after-treatment receptacle that is fluidly coupled with and disposed downstream the flow path from the upstream turbocharger, and a downstream turbocharger that is fluidly coupled with and disposed downstream the flow path from the after-treatment receptacle is provided. The method includes: filtering a particulate or reacting a gas constituent of the exhaust gas after the exhaust gas has passed through the upstream turbocharger but before the exhaust gas has passed through the downstream turbocharger.

In another aspect, the method also includes reducing a temperature of the exhaust gas in the after-treatment receptacle relative to the temperature of the exhaust gas flowing into the upstream turbocharger and reducing the temperature of the exhaust gas flowing out of the downstream turbocharger.

In another aspect, the method also includes achieving or maintaining a first pressure ratio of a pressure of the exhaust gas flowing into the upstream turbocharger to the pressure of the exhaust gas flowing out of the upstream turbocharger and a different second pressure ratio of the pressure of the exhaust gas flowing into the downstream turbocharger to the pressure of the exhaust gas flowing out of the downstream turbocharger.

In another aspect, the method also includes diverting the exhaust gas away from the after-treatment receptacle.

In another aspect, the method also includes removing the particulate from the exhaust gas flowing from the downstream turbocharger.

In another embodiment, an engine exhaust treatment system is provided that includes: an upstream temperature reduction device coupled with an engine and disposed downstream from the engine along a flow path of exhaust gas generated by the engine, the upstream temperature reduction device reducing a temperature of the exhaust flowing from the engine; an after-treatment receptacle fluidly coupled with and disposed downstream from the upstream temperature reduction device along the flow path, the after-treatment receptacle configured to receive a first filter medium that removes at least one of particulates or a gas constituent from the exhaust gas flowing from the upstream temperature reduction device along the flow path; and a downstream temperature reduction device fluidly coupled with and disposed downstream from the after-treatment receptacle along the flow path, the downstream temperature reduction device reducing the temperature of the exhaust gas flowing from the after-treatment receptacle along the flow path.

In another aspect, at least one of the upstream or downstream temperature reduction devices includes a turbocharger.

In another aspect, the upstream temperature reduction device reduces a pressure of the exhaust gas flowing from the engine and the downstream temperature reduction device reduces the pressure of the exhaust gas flowing from the after-treatment receptacle.

In another aspect, the upstream temperature reduction device is configured to produce a relatively larger pressure drop of the exhaust gas than the downstream temperature reduction device.

In another aspect, the after-treatment receptacle is configured to receive at least one of a flow through filter that removes the particulates from the exhaust gas or an oxidation catalyst that reacts with the gas constituent prior to the exhaust gas flowing into the downstream temperature reduction device.

In another aspect, a bypass valve is fluidly coupled with the upstream temperature reduction device and the after-treatment receptacle to divert the exhaust gas away from the after-treatment receptacle when the bypass valve is open.

In another aspect, the engine exhaust treatment system is included in a vehicle.

Embodiments have been described herein as relating to a first filter medium. The term “first” is merely a label (e.g., in a system having more than one filter medium, to differentiate different filter mediums from one another), and is not meant to imply or require the inclusion of more than one filter medium, unless otherwise explicitly specified in a particular embodiment.

The foregoing summary, as well as the following detailed description of certain embodiments of the presently described subject matter, will be better understood when read in conjunction with the appended drawings. As used herein, an element or step recited in the singular and proceeded with the word “a” or “an” should be understood as not excluding plural of said elements or steps, unless such exclusion is explicitly stated.

Furthermore, references to “one embodiment” or “an embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the disclosed subject matter without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the described subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the described subject matter, including the best mode, and also to enable a person of ordinary skill in the art to practice the embodiments of subject matter, including making and using any devices or systems and performing any incorporated methods. The patentable scope of the subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. An engine exhaust treatment system comprising:
an upstream turbocharger fluidly coupled with an engine and disposed downstream from the engine along a flow path of exhaust gas generated by the engine;
a downstream turbocharger fluidly coupled with the upstream turbocharger and disposed downstream from the upstream turbocharger along the flow path; and
an after-treatment receptacle fluidly coupled with and disposed between the upstream and downstream turbochargers along the flow path, the after-treatment receptacle configured to receive a first filter medium that removes at least one of particulates or a gas constituent from the exhaust gas generated by the engine, whereby the exhaust gas can flow through the upstream turbocharger prior to flowing through the after-treatment receptacle and can flow through the after-treatment receptacle prior to flowing through the downstream turbocharger along the flow path.

2. The engine exhaust treatment system of claim 1, wherein the after-treatment receptacle is disposed between the upstream and downstream turbochargers such that a pressure of the exhaust gas flowing through the after-treatment receptacle is smaller than the pressure of the exhaust gas flowing into the upstream turbocharger and is greater than the pressure of the exhaust gas flowing out of the downstream turbocharger.

3. The engine exhaust treatment system of claim 1, wherein a first pressure ratio of the upstream turbocharger differs from a second pressure ratio of the downstream turbocharger.

4. The engine exhaust treatment system of claim 1, wherein the filter medium is a flow-through filter capable of removing the particulates from the exhaust gas or an oxidation catalyst filter capable of catalyzing the gas constituent prior to the exhaust gas flowing into the downstream turbocharger.

5. The engine exhaust treatment system of claim 1, further comprising a bypass valve fluidly coupled with both the upstream turbocharger and the after-treatment receptacle, and the bypass valve having an open position and a closed position, wherein the bypass valve diverts the exhaust gas away from the after-treatment receptacle when the bypass valve is in the open position.

6. The engine exhaust treatment system of claim 5, wherein the bypass valve is fluidly coupled with the upstream turbocharger and the after-treatment receptacle between the upstream turbocharger and the after-treatment receptacle along the flow path.

7. The engine exhaust treatment system of claim 1, further including a post-turbocharger treatment receptacle fluidly coupled with and disposed downstream from the downstream turbocharger along the flow path, and the post-turbocharger treatment receptacle is configured to receive a second filter medium that removes one or more particulates from the exhaust gas generated by the engine.

8. The engine exhaust treatment system of claim 1, wherein the engine exhaust treatment system is disposed within a vehicle.

9. A method for treating exhaust gas from an engine that travels along a flow path from the engine to a treatment system, and the treatment system having an upstream turbocharger, an after-treatment receptacle that is fluidly coupled with and disposed downstream the flow path from the upstream turbocharger, and a downstream turbocharger that is fluidly coupled with and disposed downstream the flow path from the after-treatment receptacle, the method comprising:
filtering a particulate or reacting a gas constituent of the exhaust gas after the exhaust gas has passed through the upstream turbocharger but before the exhaust gas has passed through the downstream turbocharger.

10. The method of claim 9, further comprising reducing a temperature of the exhaust gas in the after-treatment receptacle relative to the temperature of the exhaust gas flowing into the upstream turbocharger and reducing the temperature of the exhaust gas flowing out of the downstream turbocharger.

11. The method of claim 9, further comprising achieving or maintaining a first pressure ratio of a pressure of the exhaust gas flowing into the upstream turbocharger to the pressure of the exhaust gas flowing out of the upstream turbocharger and a different second pressure ratio of the pressure of the exhaust gas flowing into the downstream turbocharger to the pressure of the exhaust gas flowing out of the downstream turbocharger.

12. The method of claim 9, further comprising diverting the exhaust gas away from the after-treatment receptacle.

13. The method of claim 9, further comprising removing the particulate from the exhaust gas flowing from the downstream turbocharger.

14. An engine exhaust treatment system comprising:
an upstream temperature reduction device coupled with an engine and disposed downstream from the engine along a flow path of exhaust gas generated by the engine, the upstream temperature reduction device reducing a temperature of the exhaust flowing from the engine;
an after-treatment receptacle fluidly coupled with and disposed downstream from the upstream temperature reduction device along the flow path, the after-treatment receptacle configured to receive a first filter medium that removes at least one of particulates or a gas constituent from the exhaust gas flowing from the upstream temperature reduction device along the flow path; and
a downstream temperature reduction device fluidly coupled with and disposed downstream from the after-treatment receptacle along the flow path, the downstream temperature reduction device reducing the temperature of the exhaust gas flowing from the after-treatment receptacle along the flow path.

15. The engine exhaust treatment system of claim 14, wherein at least one of the upstream or downstream temperature reduction devices includes a turbocharger.

16. The engine exhaust treatment system of claim 14, wherein the upstream temperature reduction device reduces a pressure of the exhaust gas flowing from the engine and the downstream temperature reduction device reduces the pressure of the exhaust gas flowing from the after-treatment receptacle.

17. The engine exhaust treatment system of claim 16, wherein the upstream temperature reduction device is configured to produce a relatively larger pressure drop of the exhaust gas than the downstream temperature reduction device.

18. The engine exhaust treatment system of claim 14, wherein the after-treatment receptacle is configured to receive at least one of a flow through filter that removes the particulates from the exhaust gas or an oxidation catalyst that reacts with the gas constituent prior to the exhaust gas flowing into the downstream temperature reduction device.

19. The engine exhaust treatment system of claim 14, further comprising a bypass valve fluidly coupled with the upstream temperature reduction device and the after-treatment receptacle to divert the exhaust gas away from the after-treatment receptacle when the bypass valve is open.

20. The engine exhaust treatment system of claim 14, wherein the engine exhaust treatment system is disposed in a vehicle.
